(19) United States
(12) Patent Application Publication
(10) Pub. No.: US 2015/0100246 A1
(43) Pub. Date: Apr. 9, 2015

(54) SYSTEM AND METHOD FOR PREDICTING COLON CANCER RECURRENCE

(71) Applicant: THE CLEVELAND CLINIC FOUNDATION, Cleveland, OH (US)

(72) Inventors: Feza H. Remzi, Pepper Pike, OH (US); Elena Manilich, Moreland Hills, OH (US); Mikhael Teverovskiy, Harrison, NY (US); Xiuli Liu, Cleveland, OH (US)

(21) Appl. No.: 14/508,951

(22) Filed: Oct. 7, 2014

Related U.S. Application Data
(60) Provisional application No. 61/887,573, filed on Oct. 7, 2013.

(51) Int. Cl. G06F 19/00

(52) U.S. Cl. CPC G06F 19/3431
USPC 702/19

(57) ABSTRACT

Systems and methods are provided that can predict a likelihood of post-resection colon cancer recurrence. The systems and methods can be implemented by a computing device that includes a non-transitory computer readable storage medium storing machine executable instructions and a processor that executes the machine executable instructions. Upon execution of the machine executable instructions, a feature extractor can be configured to determine a morphological feature from an image of resected tumor tissue. Upon execution of the machine executable instructions, a scorer can be configured to determine a risk score that indicates the likelihood of post-resection colon cancer recurrence based on the morphological feature. The risk score can be displayed on a user interface in a human comprehensible form.

### CROSS-REFERENCE TO RELATED APPLICATIONS

This application claims the benefit of U.S. Provisional Patent Application No. 61/887,573, filed Oct. 7, 2013, entitled PREDICTING COLON CANCER RECURRENCE BASED ON A SYSTEMS PATHOLOGY MODEL. The subject matter of this provisional application is incorporated herein by reference in its entirety.

### FIELD OF THE INVENTION

The present disclosure relates generally to the prediction of colon cancer recurrence and, more specifically, to systems and methods that can predict a likelihood of post-resection colon cancer recurrence based on a systems pathology model.

### BACKGROUND

Generally, colon cancer, which originates in the large intestine or the rectum, can be treated by surgical removal of all of the cancerous tissue (or “resection”). After the resection, a probability of disease-free survival post-resection can be established based on the tumor-nodes-metastasis (TNM) cancer staging system, where different stages (e.g., Stage I, Stage II, and Stage III) correspond to an increasingly worse probability of survival. Accordingly, Stage I or Stage II colon cancer patients generally can expect a low chance of recurrence post-resection; however, some Stage I and Stage II patients will develop recurrence. However, the TNM staging system cannot predict which specific Stage I and Stage II patients will be more likely to experience a post-resection recurrence.

### SUMMARY

The present disclosure relates generally to the prediction of colon cancer recurrence and, more specifically, to systems and methods that can predict a likelihood of post-resection colon cancer recurrence based on a systems pathology model.

In accordance with an aspect of the present disclosure, a non-transitory computer readable medium stores machine executable instructions that, when executed by an associated processor, can provide a system that can predict a likelihood of colon cancer recurrence (or “risk score”) post-resection. The system can include a feature extractor, a scorer, and a user interface. The feature extractor can be configured to determine at least one morphological feature (e.g., an extent/degree of heterogeneity of tumor necrosis and/or a degree of heterogeneity of pre-cancer tissue) from one or more images of resected tumor tissue. The scorer can be configured to determine the risk score based on the at least one morphological feature. The user interface can be configured to display the risk score to a user in a human comprehensible form.

### BRIEF DESCRIPTION OF THE DRAWINGS

The foregoing and other features of the present invention will become apparent to those skilled in the art to which the present invention relates upon reading the following description with reference to the accompanying drawings, in which:

FIG. 1 is a block diagram depicting a system that can predict a likelihood of colon cancer recurrence in a patient, according to an aspect of the present disclosure;

FIG. 2 is a block diagram depicting an example functionality of the feature extracter in the system of FIG. 1;

FIG. 3 includes a series of images that can be used to determine a morphometric factor that can be used to predict a likelihood of colon cancer recurrence in a patient by the extracter in the system of FIG. 1;

FIG. 4 is a block diagram depicting an example functionality of the scorer in the system of FIG. 1;

FIG. 5 is a process flow diagram depicting a method for predicting a likelihood of colon cancer recurrence in a patient, according to an aspect of the present disclosure;

FIG. 6 is a process flow diagram depicting a method for analyzing an image to determine a morphometric factor that can be used to predict a likelihood of colon cancer recurrence in a patient, according to an aspect of the present disclosure;

FIG. 7 is a block diagram depicting an example of a system of hardware components capable of implementing examples of the system of FIG. 1 and/or the methods of FIGS. 5 and 6.

### DETAILED DESCRIPTION

### I. Definitions

In the context of the present disclosure, the singular forms “a,” “an” and “the” can also include the plural forms, unless the context clearly indicates otherwise. The terms “comprises” and/or “comprising,” as used herein, can specify the presence of stated features, steps, operations, elements, and/or components, but do not preclude the presence or addition of one or more other features, steps, operations, elements, components, and/or groups. As used herein, the term “and/or” can include any and all combinations of one or more of the associated listed items. Additionally, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or acts/steps) is not limited to the order presented in the claims or figures unless specifically indicated otherwise.

As used herein, the term “systems pathology model” can refer to a set of features associated with reduced overall survival (e.g., colon cancer recurrence) in patients after surgical resection.

As used herein, the term “risk score” can refer to a chance of colon cancer recurrence in a patient after surgical resection based on the systems pathology model. In some instances, the risk score can be a percentage indicating a chance of the colon cancer recurrence.

As used herein, the term “resection” can refer to the surgical removal of all of the cancerous tissue that is visible.

As used herein, the term “patient” can refer to any warm-blooded organism, including, but not limited to, human beings, pigs, rats, mice, dogs, goats, sheep, horses, monkeys, apes, rabbits, cattle, etc.

### II. Overview

The present disclosure relates generally to the prediction of colon cancer recurrence and, more specifically, to systems and methods that can predict a likelihood of post-resection colon cancer recurrence based on a systems pathology model. The systems pathology model can provide clinicians with a computation tool based on quantitative analyses of histopathologic images to accurately predict disease recurrence. The systems and methods described herein can identify patients with a high risk of colon cancer recurrence who potentially could benefit from additional therapy after the surgical resection of the tumor.

### III. Systems

One aspect of the present disclosure can include a system that can predict a likelihood of colon cancer recurrence in a patient. Based on the likelihood of colon cancer recurrence, patients can be identified that potentially could benefit from additional therapy after surgical resection of the tumor. The system can fuse heterogeneous data including clinical factors and various pathologic features that can be automatically extracted from tumor images into a single prognostic model. The system can utilize a set of advanced imaging algorithms, including unsupervised segmentation to evaluate the entire cancer architecture, to segment images automatically into major meaningful histopathological components and extract a broad spectrum of quantitative textual measurements from these components. The factors utilized by the system were determined based on a non-parametric random survival forest methodology can identify factors that most accurately predicts the survival of colon cancer patients.

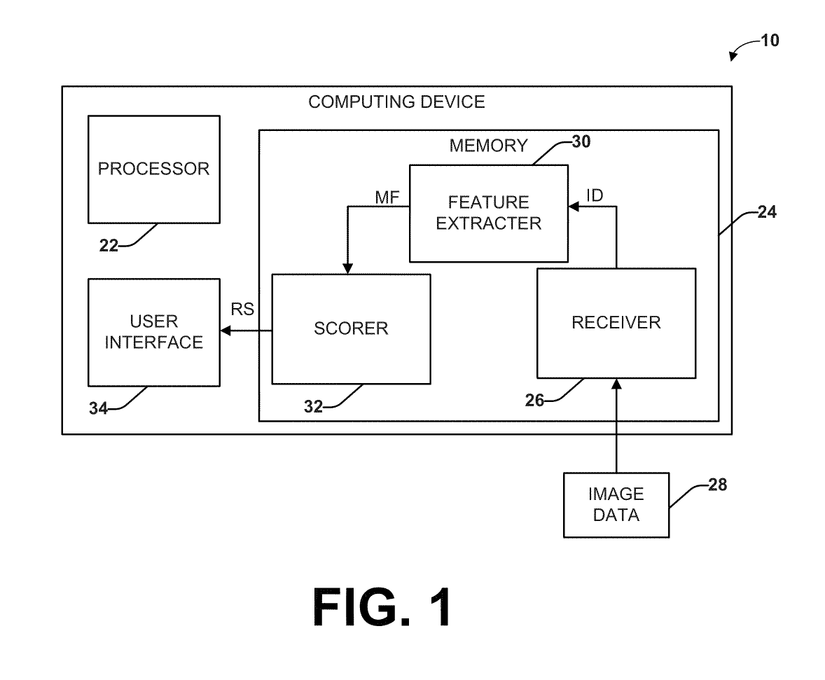

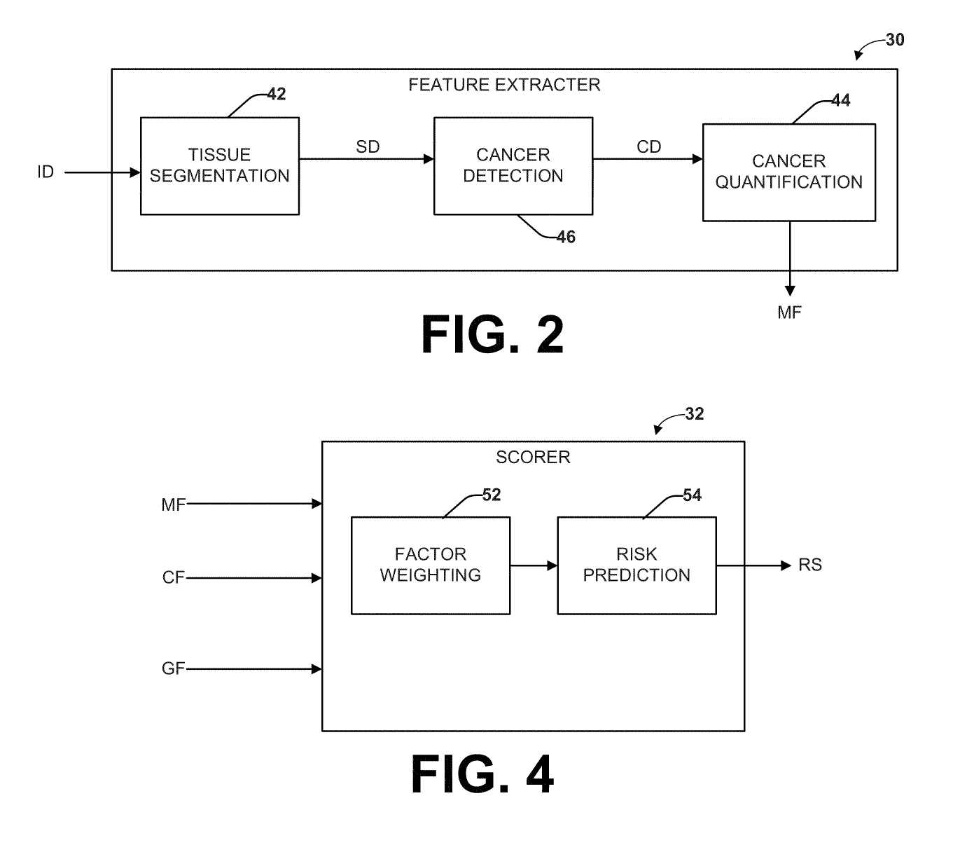

FIG. 1, as well as associated FIGS. 2 and 4, are schematically illustrated as block diagrams with the different blocks representing different components. The functions of one or more of the components can be implemented by computer program instructions. These computer program instructions can be provided to a processor of a general purpose computer, special purpose computer, and/or other programmable data processing apparatus to produce a machine, such that the instructions, which execute via the processor of the computer and/or other programmable data processing apparatus, create a mechanism for implementing the functions of the components specified in the block diagrams.

These computer program instructions can also be stored in a non-transitory computer-readable memory that can direct a computer or other programmable data processing apparatus to function in a particular manner, such that the instructions stored in the non-transitory computer-readable memory produce an article of manufacture including instructions, which implement the function specified in the block diagrams and associated description.

The computer program instructions can also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions of the components specified in the block diagrams and the associated description.

Accordingly, one or more components described herein can be embodied at least in part in hardware and/or in software (including firmware, resident software, micro-code, etc.). Furthermore, aspects of the system can take the form of a computer program product on a computer-usable or computer-readable storage medium having computer-usable or computer-readable program code embodied in the medium for use by or in connection with an instruction execution system. A computer-usable or computer-readable medium can be any non-transitory medium that is not a transitory signal and can contain or store the program for use by or in connection with the instruction or execution of a system, apparatus, or device. The computer-usable or computer-readable medium can be, for example but not limited to, an electronic, magnetic, optical, electromagnetic, infrared, or semiconductor system, apparatus or device. More specific examples (a non-exhaustive list) of the computer-readable medium can include the following: a portable computer diskette; a random access memory; a read-only memory; an erasable programmable read-only memory (or Flash memory); and a portable compact disc read-only memory.

Referring now to FIG. 1, illustrated is a block diagram depicting a system (e.g. implemented by computing device 10) that can predict a likelihood of colon cancer recurrence (or “risk score”) in a patient, according to an aspect of the present disclosure. The prediction can be based on a systems pathology model. The computing device 10 can include various hardware components, including a processor 22, a non-transitory memory 24, and a user interface 34. The memory 24 can store instructions that when executed by processor 22 can provide the system. The system can include a receiver 26, a feature extracter 30, and a scorer 32.

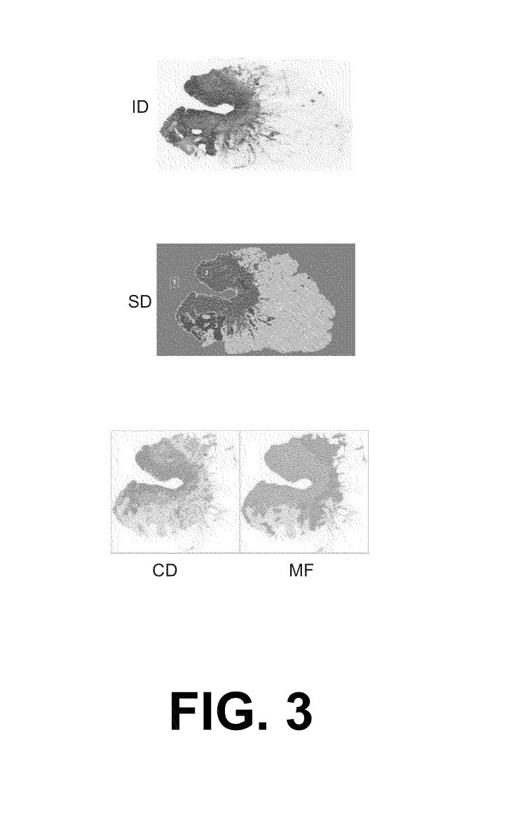

The receiver 26 can receive an input of image data 28 taken post resection of a tumor. The receiver 26 can perform introductory pre-processing tasks on the image data 28 before providing processed image data (ID) to the feature extracter 30. The feature extracter 30 can perform an image analysis technique to determine a morphological feature (MF) of the processed image data (ID). As shown in FIGS. 2 and 3, the feature extracter 30 can receive the processed image data (ID). A tissue segmentation component 42 can the processed image data and output segmented image data (SD). The image 12 can be, for example, one or more digitized histopathologic slides corresponding to one or more slices of the resected tumor tissue. In one example, shown in FIG. 3, the image data (ID) can include hematoxylin and eosin (H&E)-stained slides of colon tissue.

In some instances, the tissue segmentation component 42 can segment the processed image data into histopathologic components and extracting one or more quantitative measurements from the histopathologic components. The segmentation can be a fully automated, multi step process, which can sequentially identify key components of colon tissue. For example, the key components can include background, epithelium, stroma, and white space. Examples of the histopathologic components include at least a tumor necrosis region and precancer region and the quantitative measurements can include morphological features of the tumor necrosis feature from the tumor necrosis region (e.g., an extent/degree of heterogeneity of the tumor necrosis) and from the precancer region (a degree of heterogeneity of the precancer region). As an example, the extraction of the quantitative measurements by the feature extracter 30 can be based on a comparison between the histopathologic components of the image data (ID) to stored histopathologic components.

A cancer detection component 46 can detect cancer regions within the segmented image data and output an image with detected cancer regions (CD). For example, the cancer regions can include stroma, necrosis and lumens. Since cancer is a heterogeneous region that includes several tissue components cancer region can be identified using spatial relationships between cancer elements. The epithelium region can be used as an anchor in an iterative region expansion this process. Epithelium objects expand by sequentially absorbing small stromal and white space objects. A stromal or a white space object is absorbed if it is located within the rectangular bounding box built around expanding epithelium object. This condition defines spatial and size relationships between epithelium and adjoined objects. Expansion ends when the relative area of the cancer region does not change.

The cancer quantification component 44 can determine a morphological feature (MF) based on the detected cancer regions (CD). Cancer heterogeneity can be used for sub-segmentation of the cancer regions. For example, unsupervised texture segmentation by k-means clustering algorithm can be used to partition the cancer region in 4 clusters. Texture can be represented by frequency vectors from intensity histograms in m×m patches around pixels (m=5). Principal Component Analysis can be applied to decrease feature dimension (10 components keep 85% of data variations) for clustering. Cluster labels can differ from image to image since their clustering is done independently, so the clusters need to be classified over all images.

In some instances, mutual proximity of cluster centers can be used to classify the clusters. The proximity can be described by a matrix D that contains pairwise Euclidean distances dᵢⱼ=dⱼᵢ between two centers i and j. Elements of matrix D can be normalized such that max_{i,j}=1. The most distanced points i. and j. (d_{i.j.}=1) form two classes: ζ₁ and ζ₂ have all points within distance d. from i. and j., respectively. Remaining points fall in class ζ₂. Value d.=0.4 used for the classification. The created classes ζₖ, (k=1, 2, 3) can allow for unified cluster labeling over all images in the set. Cluster evaluation by a pathologist (or a trained computer model based on historical evaluations by one or more pathologists) can clarify their meaning: necrosis (ζ₁), stroma (ζ₂) and lumens (ζ₃).

Measurements extraction from segmented images can complete tissue image analysis and generate the morphological feature (MF). For example, two regions can be subjected for measurements: the entire cancer and cancer necrosis. Four categories of measurements can be considered: area/perimeter, color, fractal dimension of region boundaries and texture features. Area measurements can measure values of absolute areas (in pixels) and area ratios. For example, areas of tissue components, relative (with respect to the tissue) areas of the cancer and necrosis, ratio of cancer clusters areas. As an example, color measurements can be mean and standard deviation values of intensities calculated over a region image objects for red, green and blue components of original image. Boundary fractal dimensions of cancer and necrosis regions are calculated by the box counting algorithm. Examples of textures measurements can include: a) Haralick features and b) local contrast and entropy. One or more of these textures measurements can be sent to the scorer as the morphological feature (MF).

The scorer 32 can determine the risk score (RS) based on the systems pathology model, a type of predictive model that can determine the risk score (RS) that indicates the risk of colon cancer recurrence post-resection, such as a categorical model, a regressive model, a group method of data handling model, or the like. One non-limiting example predictive model described herein is derived via a non-parametric random survival forest (RSF) process, which provides an unbiased measure of relative importance (or predictive significance) of parameters related to colon cancer survival post-resection such that the parameters that exhibit the greatest importance are used by scorer 32 as variables of the systems pathology model. For example, the systems pathology model can integrate clinical features, quantitative imaging morphological features, and genetic data (e.g., based on molecular biomarker profiles). The systems pathology model can improve the accuracy of cancer outcome predictive models.

The scorer 32 can be configured to use the one or more morphological features (MF) to determine the risk score (RS). For example, morphological features can include the Haralick features and/or local contrast and entropy values. The risk score (RS) can be any measure of risk for a patient to develop recurrence post-resection. For example, the risk score (RS) can categorize (or be used to categorize) the patient into at least one of a plurality of distinct risk classes. In an embodiment, the risk score can be a measure that further stratifies the early TNM stages (e.g., Stage I and Stage II) into distinct survival subgroups. As an example, Stage IA can represent a TNM Stage I colon cancer with a low risk of recurrence, while Stage IB can represent a TNM Stage I colon cancer with a high risk of recurrence that may benefit from further treatment post-resection.

Optionally, as shown in FIG. 4, scorer 32 can use additional/other parameters (e.g., a clinical feature (CF) and/or a genetic feature (GF)) to determine the risk score (RS). These features (CF), (GF) can be determined to by the non-parametric RSF process to be additional predictors of recurrence. For example, the non-parametric RSF process can determine that these features (CF), (GF) are less significant predictors (e.g., having a lower weight) than the one or more morphological features (MF), but still exhibit some predictive value. The genetic feature (GF) can include data related to a microsatellite instability (MSI) status of the resected tumor tissue, which is input to scorer 32. The MSI status can indicate an increased risk for main cancers, including colon cancer. MSI can indicate an abnormal function of the DNA Mismatch Repair (MMR) gene products. The MSI status can be based on a PCR-based assay (or MSI-PCR). The clinical data (CF) can include data related to an age of the patient at the time of the resection. The clinical data (CF) can be input into the scorer 32 by user-input and/or according to an artificial intelligence technique that can be employed by the receiver 26 (e.g., retrieving the age from metadata associated with the image data).

The scorer 32 can send the risk score (RS) to the user interface 34 for display (e.g., to a physician). The display can also include other information associated with the risk score. For example, the display can include a suggested treatment plan based on the risk score. The user interface 34 can be configured to display the risk score (RS) to a user in a human comprehensible form. Specifically, the user interface 34 can interact with a display, printer, speaker, or other appropriate output device to provide the risk score (RS) that represents the likelihood of post-resection colon cancer recurrence to a user. The user can be a treating physician, who can determine the need for further treatment for the patient post-resection based on the risk score (RS).

### IV. Methods

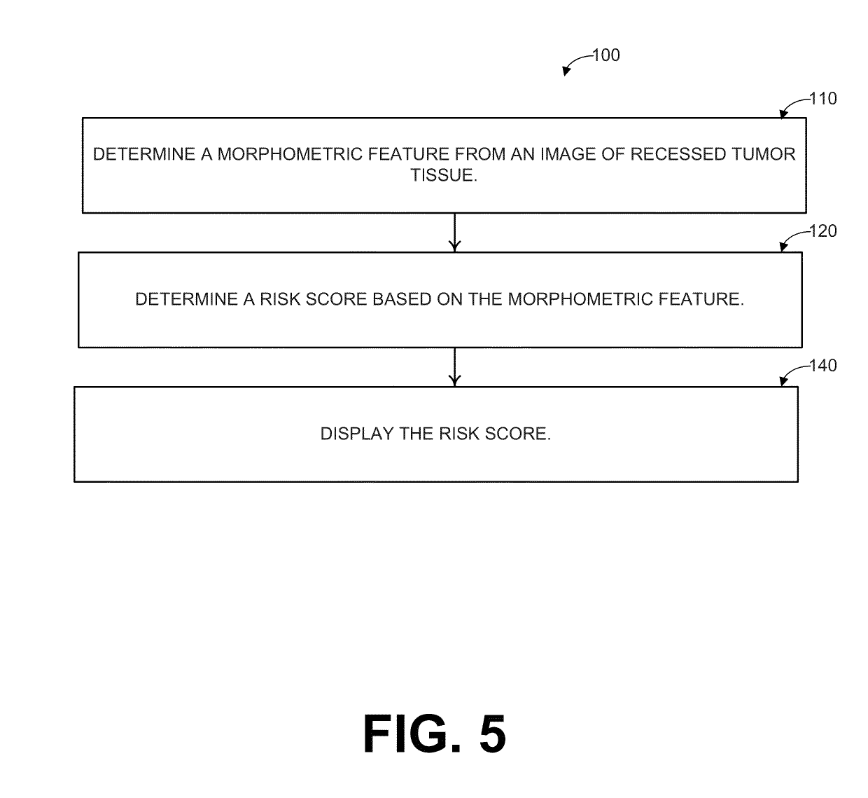

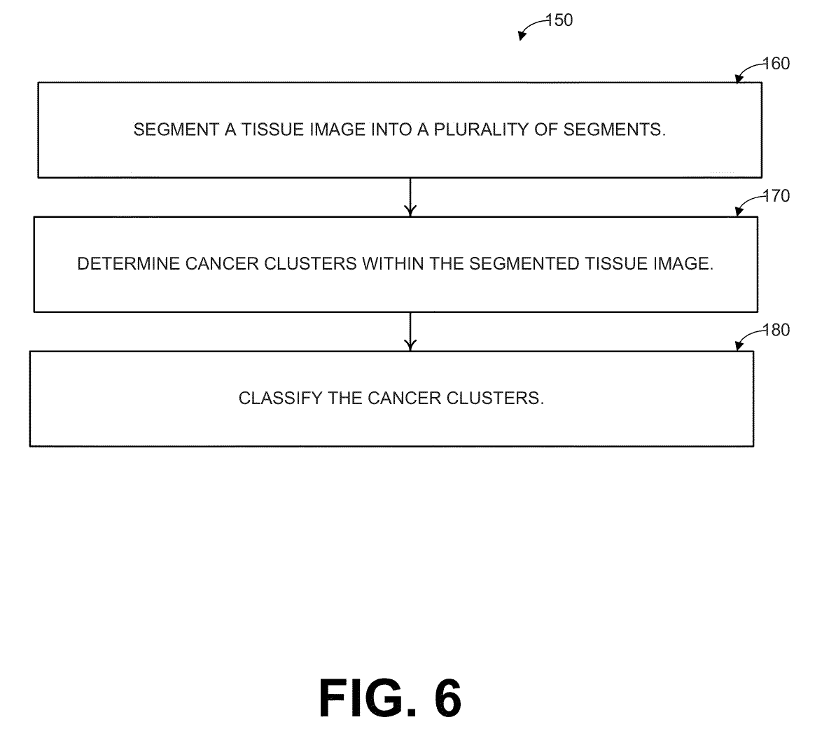

Another aspect of the present disclosure can include methods for predicting a likelihood of colon cancer recurrence in a patient. One example method 100 for determining a risk score that can be used to predict the likelihood of colon cancer recurrence in a patient is shown in FIG. 5. Another example method 150 for determining a morphological feature that can contribute to the prediction of the likelihood of colon cancer recurrence in the patient is shown in FIG. 6.

The methods 100 and 150 of FIGS. 5 and 6 is illustrated as process flow diagrams with flowchart illustrations. For purposes of simplicity, the methods 100 and 150 are shown and described as being executed serially; however, it is to be understood and appreciated that the present disclosure is not limited by the illustrated order as some steps could occur in different orders and/or concurrently with other steps shown and described herein. Moreover, not all illustrated aspects may be required to implement the methods 100 and 150.

One or more blocks of the respective flowchart illustrations of FIGS. 5 and 6, and combinations of blocks in the block flowchart illustrations, can be implemented by computer program instructions. These computer program instructions can be stored in memory and provided to a processor of a general purpose computer, special purpose computer, and/or other programmable data processing apparatus to produce a machine, such that the instructions, which execute via the processor of the computer and/or other programmable data processing apparatus, create mechanisms for implementing the steps/acts specified in the flowchart blocks and/or the associated description. In other words, the steps/acts can be implemented by a system comprising a processor that can access the computer-executable instructions that are stored in a non-transitory memory.

Referring now to FIG. 5, illustrated is a process flow diagram depicting a method 100 for predicting a likelihood of colon cancer recurrence in a patient, according to an aspect of the present disclosure. At 110, a morophometric feature (e.g., MD) can be determined (e.g., by feature extracter 30) from an image of recessed tumor tissue (e.g. ID). At 120, a risk score can be determined (e.g., by scorer 32) based on the morphometric feature. In some instances, other features can be utilized in combination with the morphometric feature to determine the risk score. The additional features can include features indicated by the system pathology model as being predictive of a risk of colon cancer recurrence. Example features can include, clinical features (e.g., CF) and/or genetic features (e.g., GF). At 140, the risk score (e.g., RS) can be displayed (e.g., on user interface 34). In some instances, the display can include additional information in connection with the risk score. For example, the additional information can include a proposal of further therapy that can be used to reduce the risk score.

Referring now to FIG. 6, illustrated is a process flow diagram depicting a method 150 for analyzing an image (e.g., by feature extracter 30) to determine a morphometric factor that can be used to predict a likelihood of colon cancer recurrence in a patient, according to an aspect of the present disclosure. At 160, a tissue image (e.g., ID) can be segmented into a plurality of segments (e.g., SD). The image segmentation can be a fully automated, multistep process, which sequentially identifies the key components of colon tissue. For example, the key components can include background, epithelium, stroma, and white space. At 170, cancer clusters can be determined (e.g., CD) within the segmented tissue image. At 180, the cancer clusters can be classified (e.g., MF). For example, the cancer clusters and the classification of the cancer clusters can be based on the heterogeneity of cancer tissue.

### V. Example Computer System

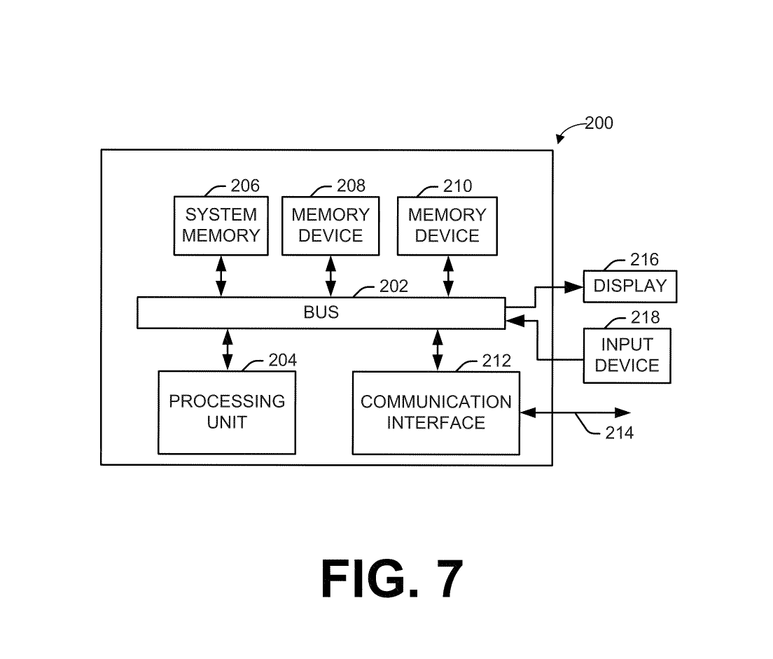

FIG. 7 is a block diagram illustrating an exemplary system 200 of hardware components capable of implementing examples of the systems and methods of FIGS. 1 and 5-6. The system 200 can include various systems and subsystems, including a personal computer, a laptop computer, a workstation, a computer system, an appliance, an application-specific integrated circuit (ASIC), a server, a server blade center, a server farm, etc.

The system 200 can includes a system bus 202, a processing unit 204, a system memory 206, memory devices 208 and 210, a communication interface 212 (e.g., a network interface), a communication link 214, a display 216 (e.g., a video screen), and an input device 218 (e.g., a keyboard and/or a mouse). The system bus 202 can be in communication with the processing unit 204 and the system memory 206. The additional memory devices 208 and 210, such as a hard disk drive, server, stand alone database, or other non-volatile memory, can also be in communication with the system bus 202. The system bus 202 interconnects the processing unit 114, the memory devices 206-210, the communication interface 212, the display 216, and the input device 128. In some examples, the system bus 112 also interconnects an additional port (not shown), such as a universal serial bus (USB) port. The processing unit 204 can be a computing device that executes a set of instructions to implement the operations of examples disclosed herein. The processing unit 204 can include a processing core.

The memory devices 206, 208 and 210 can store data, programs, instructions, database queries in text or compiled form, and any other information that can be needed to operate a computer. The memory devices 206, 208 and 210 can be implemented as tangible computer-readable media (integrated or removable) such as a memory card, disk drive, compact disk (CD), or server accessible over a network. In certain examples, the information stored on the memory devices 206, 208 and 210 can comprise text, images, video, and/or audio, portions of which can be available in formats comprehensible to human beings. Additionally or alternatively, the system 200 can access an external data source or query source through the communication interface 212, which can communicate with the system bus 202 and the communication link 214.

In operation, the system 200 can be used to implement one or more parts of a system or method 100 that can predict a likelihood of post-resection colon cancer recurrence based on a systems pathology model in accordance with the present disclosure. Computer executable logic for implementing the system or method 100 can reside on one or more of the system memory 206 and the memory devices 208, 210 in accordance with certain examples. The processing unit 204 can execute one or more computer executable instructions originating from the system memory 206 and/or the memory devices 208 and 210. The term “computer readable medium” as used herein refers to a medium that participates in providing instructions to the processing unit 204 for execution, and can, in practice, refer to multiple, operatively connected apparatuses for storing machine executable instructions.

What have been described above are examples of the systems and methods that can predict a likelihood of post-resection colon cancer recurrence based on a systems pathology model. It is, of course, not possible to describe every conceivable combination of components or methods for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A non-transitory computer readable medium storing machine executable instructions that, when executed by an associated processor, provide a system for predicting a likelihood of post-resection colon cancer recurrence, the system comprising:
a feature extractor configured to determine a morphological feature from an image of resected tumor tissue;
a scorer configured to determine a risk score that predicts the likelihood of post-resection colon cancer recurrence based on the morphological feature; and
a user interface configured to display the risk score in a human comprehensible form.

2. A method, comprising:
receiving, by a system comprising a processor, image data comprising an image of colon tissue after tumor resection;
determining, by the system, a morphological feature represented in the image data;
determining, by the system, a risk score predicting the likelihood of post-resection colon cancer recurrence based on the morphological feature.

3. The method of claim 2, further comprising pre-processing the image data to retrieve clinical features from metadata related to the image data.

4. The method of claim 3, wherein the determining the risk score is further based on the clinical features.

5. The method of claim 2, wherein the determining the risk score is further based on genetic features.

6. The method of claim 2, wherein the morphological feature comprises at least one of a Haralick features and a local contrast and entropy feature.

7. The method of claim 2, wherein the determining the morphological feature further comprises:
segmenting tissue represented by the image data into a plurality of segments;
determining cancer clusters within the segmented tissue; and
classify the cancer clusters with respect to the morphological feature.
